(19) United States
(12) Patent Application Publication
(10) Pub. No.: US 2014/0279140 A1
(43) Pub. Date: Sep. 18, 2014

(54) METHODS FOR FACILITATING CONSIGNMENT AND SALES OF INVENTORY OR SERVICES, AND FOR TRIGGERING CONTENT

(71) Applicant: Joseph M. Kar, Sherman Oaks, CA (US)

(72) Inventor: Joseph M. Kar, Sherman Oaks, CA (US)

(21) Appl. No.: 13/846,245

(22) Filed: Mar. 18, 2013

(51) Int. Cl. G06Q 30/08

(52) U.S. Cl. CPC G06Q 30/08
USPC 705/26.3

(57) ABSTRACT

Methods of facilitating the sale of wares offered from vendors to buyers and for triggering content to the buyers through an intermediary platform in communication with the vendors and the buyers over an Internet include the intermediary platform and the buyer bargaining via a haggling process for a final sale price of a ware. During the haggling process, or if no bargain is reached for the ware in the haggling process or the haggling process for the item times-out after a transaction duration of time from the beginning of the haggling process elapses, the method includes the intermediary platform presenting content to the buyer. In response to the buyer interacting with the content, the method further includes the intermediary platform reinitiating the haggling process between the intermediary platform and the buyer for the ware.

### FIELD OF THE INVENTION

The present invention is directed to a system and method for facilitating the sales transactions of inventory and/or services on a consignment basis, for example, by utilizing the Internet, or other communication devices, and for triggering content.

### BACKGROUND OF THE INVENTION

Historically, particularly in remote rural areas, sales persons or vendors traveled to their potential customers (whether retail, wholesale or raw materials) utilizing a covered wagon to store their wares. The customers would then examine these wares and the sale would be consummated. While some of these goods might carry a stated price therewith, the customers could be encouraged to bargain with the sales person before the sale was finalized. Likewise, buyers in need of services, for example, plumbing repair, carpentry, therapies, may seek out local vendors and often bargain over the price for the services before a sale is consummated.

The invention and utilization of motorized vehicles strikingly changed the demographics of our country, allowing suburbs to spring up in proximity to urban areas. The use of these vehicles changed the manner in which individuals would shop for goods or services. Rather than the sales person coming to the customers, individualized stores, shopping centers, and specialized service providers were established in which the customers traveled to these sales outlets. Based upon the size of the establishment as well as the personnel employed by the sellers, the stated sale price of a particular item could not be changed by the sales person and bargaining or haggling over this sales price was either discouraged or totally eliminated.

However, evolving technology has again altered the manner in which the buying public purchases various goods or services. This change in purchasing habits has also been precipitated by the change in the way of life of the purchasing public. For example, a large number of both partners in a marriage now work full time. When children are added to this couple's family, schedules can become very hectic. Therefore, many people are having a very difficult time finding sufficient time to comparatively shop or even travel to brick and mortar outlets to examine and purchase items. More and more of these brick and mortar stores are utilizing mail order catalogs to display their goods and to prompt the buyers to order these goods over the telephone.

Another change of technology which has altered the manner in which the public purchases goods or services would be the Internet. Virtually any company of even a modicum size has developed their own web pages allowing individuals to purchase goods or services on-line. These purchases would then be sent to the purchaser's residences without requiring the purchaser to travel to the brick and mortar establishment. Or, if a service, the customer would more conveniently and economically have the needed services provided to them.

The Internet also allows for the on-line purchase of goods generated by a secondary market such as items owned by an individual and not the original vendor. Rather than leaving these unneeded but still usable items to waste or to consignment stores for sale, a number of Internet websites are dedicated to the on-line sale of these items, including the sale of collectibles. One such known system and method for processing the on-line sale of a secondary market item utilizes an intermediary company that act as a vehicle allowing sellers to advertise various items on the Internet which can be purchased by respective buyers. The intermediary company operates a website to illustrate the items for sale as well as include a purchase price. If a particular buyer wishes to purchase one or more of these sale items, the sale can be consummated over the Internet. Once this sale is consummated, a legally binding contract has been forged between the buyer and the seller. At this point, that item would be transported to the buyer and the seller would be properly compensated. The use of bargaining over the purchase price between a vendor and the buyer, with the intermediary working to coordinate the sale, negotiation, and consummation of each transaction, is useful in that it promotes or otherwise facilities the sales transaction. Such bargaining often fails, or sometimes results in the seller or buyers accepting a less-than-satisfying transaction, which can be disappointing. What is needed in the art of on-line sales and bargaining to facilitate sales transactions is a way to facilitate the furtherance of ongoing bargaining when an initial sales transaction fails should the vendor and buyer fail to successfully bargain to a mutually-acceptable sales price, and to maintain the buyer's attention and to encourage the buyer to engage in the on-line bargaining process. What is also needed in the field of on-line sales and bargaining is the triggering of content to maintain the buyer's attention, in the event the vendor or the buyer are unable to consummate a transaction or arrive at a mutually-agreed price in a pending or failed sales transaction.

### SUMMARY OF THE INVENTION

This disclosure involves the use of bargaining over the purchase price between a vendor and the buyer, with an intermediary working to coordinate the sale, negotiation, and consummation of each transaction. According to the principle of the invention, provided are systems and methods for sales of inventory through an intermediary by facilitating transactions between buyers and vendors directly or indirectly by means of electronic or digital communication. The inventory consists of wares, namely, goods in one embodiment, services in another embodiment, and goods and services in yet another embodiment. Although the present invention contemplates the utilization of a consignment technique, it should not be so limited and other types of sales relationships could be employed between the intermediary and the vendors. A number of vendors would advertise their goods or services through a website and/or platform developed by the intermediary. The intermediary would display images, descriptions, marketing material, and attributes of the products or services vendors wish to sell. Additionally, each of the vendors may include a suggested retail price to be associated with each of the items/wares for sale. The terms items and wares are interchangeable terms according to this disclosure. When a potential buyer contacts the intermediary by either logging on to the intermediary's website, by telephone, or wireless device, or in conjunction with a sales catalog, the buyer would have the potential to negotiate over and purchase and/or order the goods or services advertised by one or more of the vendors. Although each of the advertised goods or services may include a suggested retail price, the present invention would contemplate that a haggling process can be entered into between the buyer and the vendor. The vendor must also inform the intermediary of a minimum sale price for each of the items. The intermediary would create or be provided with a haggle table used to produce counter offers to each of the buyer's offers. This haggling or bargaining process would continue until a final offer is made by either the buyer or the seller. At this point, if the buyer or seller accepts either parties' final offer, a sale would be consummated and the particular sales item or service would be delivered from the vendor to the buyer. It is important to note that none of the items could be sold at a price lower than the minimum sale price without the vendor's prior authorization.

Since many of the vendors utilizing the system of the present invention would be brick and mortar stores in which inventory can be depleted by sales consummated at the sellers' premises, either over the telephone, or with buyers traveling to the brick and mortar stores, it would be important for the operation of the present invention to insure that each of the vendors would be in a position to supply the sales which would be made over the intermediary's system. Therefore, each of the vendors would be required to maintain a separate “virtual” inventory and an in-store inventory. The intermediary would inform that particular vendor when the virtual inventory has been depleted and automatically default to the conditional purchase feature. The conditional purchase feature enables a customer to place an advance order for the desired, but “out of stock” or unavailable good or service. In recognition of the buyer's advance order, the vendor may implement an incentive price or discount from the suggested retail price or create any other incentive to attract advance orders. Furthermore, if this virtual inventory has not been depleted but the in-store inventory has been depleted, the vendor would be able to apportion the virtual inventory to fulfill sales for the vendor's brick and mortar establishment.

Although it is contemplated that the major areas of coordination between the buyers and the intermediary would be over the Internet or wireless service, other types of communication could be used. For example, the intermediary could be equipped with a voice recognition system allowing the haggling process to be undertaken over the telephone with the voice recognition system having access to the haggle table so that proper counteroffers would be presented to the potential buyers. Alternatively, a vendor could directly interact with the customer to produce a counter offer without the use of the voice recognition system, for example, by e-mails through the intermediary.

In a particular embodiment, a method of facilitating the sale of wares offered from vendors to buyers and for triggering content to the buyers includes the steps of providing an intermediary platform in communication with vendors and buyers over an Internet, the intermediary platform including a memory device associated with a processor, each of the vendors providing the intermediary platform with descriptive information relating to each of wares offered by the vendors, the descriptive being information stored in the memory device and comprising a retail sales price and a minimum sales price and a description of the wares offered, for each of the wares, constructing at least one haggle table, the haggle table stored in the memory device associated with the processor located at the intermediary platform, initiating a haggle process by the intermediary platform offering the retail price of each of the wares to the buyers, a buyer responding to the initiating step by communicating to the intermediary platform a first counter offer to the retail price of a first of the wares, and the intermediary platform comparing the counter offer to the minimum sales price of the first of the wares, wherein the haggle table comprises a list of desired discount amounts, used to produce counter offers responsive to a buyer's offer or counter offer for a particular ware offered by at least one of the vendors, the desired discount amount equaling a buyer's offered price deducted from the retail sales price so as to allow a vendor to counteroffer based on a random selection within a pre-defined range. The method further includes continuing the haggle process if the counter offer is not accepted by the intermediary platform, with the intermediary platform determining a second counter offer utilizing the retail sales price, the counter offer, and the minimum sales price, the intermediary platform presenting the second counter offer to the buyer encouraging the buyer to make a third counter offer, and further continuing the haggle process for the first of the wares until one of a final offer is accepted, the buyer presents a final counter offer that not accepted by the intermediary platform, and no additional counter offers are made by the buyer or vendor. The method further includes the intermediary platform terminating the haggle process for the first of the wares in response to no accepting of a final offer, the buyer presenting a final counter offer that is less than the minimum sales price, and no presenting of additional counter offers by the buyer and the intermediary platform, and in response to the intermediary platform terminating the haggle process for the first of the wares, the intermediary platform presenting content to the buyer, the content being at least one of textual, visual, verbal, and aural content. The method next includes the buyer interacting with the content, and the intermediary platform reinitiating the haggle process between the intermediary platform and the buyer for the first of the wares in response to the buyer interacting with the content. In one embodiment, the content is an advertisement. In another embodiment, the content is one of a questionnaire and a survey. Other forms of content that do not trigger a reinitiating of the haggle process include such content as a rebate, a coupon, a search field for accepting buyer input to be searched, a suggested ware for a buyer to purchase directly or to purchase through a haggling process, and a one-time purchase ware, which is ware that a buyer is given the opportunity to buy at a one-time purchase price without the possibility of haggling.

Another method of facilitating the sale of wares offered from vendors to buyers and for triggering content to the buyers includes the steps of providing an intermediary platform in communication with vendors and buyers over an Internet, the intermediary platform including a memory device associated with a processor, each of the vendors providing the intermediary platform with descriptive information relating to each of wares offered by the vendors, the descriptive information being stored in the memory device and comprising a retail sales price and a minimum sales price and a description of the wares offered, for each of the wares, constructing at least one haggle table, the haggle table stored in the memory device associated with the processor located at the intermediary platform, initiating a haggle process by the intermediary platform offering the retail price of each of the wares to the buyers, a buyer responding to the initiating step by communicating to the intermediary platform a first counter offer to the retail price of a first of the wares, and the intermediary platform comparing the counter offer to the minimum sales price of the first of the wares, wherein the haggle table comprises a list of desired discount amounts, used to produce counter offers responsive to a buyer's offer or counter offer for a particular ware offered by at least one of the vendors, the desired discount amount equaling a buyer's offered price deducted from the retail sales price so as to allow a vendor to counteroffer based on a random selection within a pre-defined range. The method further includes continuing the haggle process if the counter offer is not accepted by the intermediary platform, with the intermediary platform determining a second counter offer utilizing the retail sales price, the counter offer, and the minimum sales price, the intermediary platform presenting the second counter offer to the buyer encouraging the buyer to make a third counter offer, and further continuing the haggle process for the first of the wares until one of a final offer is accepted, and one of the buyer and the intermediary platform fails to respond to a counter offer within a designated time period. This method further includes the intermediary platform terminating the haggle process for the first of the wares in response to one of the buyer and the intermediary platform failing to respond to a counter offer within the designated time period, and in response to the intermediary platform terminating the haggle process for the first of the wares, the intermediary platform presenting content to the buyer, the content being at least one of textual, visual, verbal, and aural content. The method next includes the buyer interacting with the content, and the intermediary platform reinitiating the haggle process between the intermediary platform and the buyer for the first of the wares in response to the buyer interacting with the content. In one embodiment, the content is an advertisement. In another embodiment, the content is one of a questionnaire and a survey. Other forms of content that do not trigger a reinitiating of the haggle process include such content as a rebate, a coupon, a search field for accepting buyer input to be searched, a suggested ware for a buyer to purchase directly or to purchase through a haggling process, and a one-time purchase ware, which is ware that a buyer is given the opportunity to buy at a one-time purchase price without the possibility of haggling.

Yet another embodiment of a method of facilitating the sale of wares offered from vendors to buyers and for triggering content to the buyers includes the steps of providing an intermediary platform in communication with vendors and buyers over an Internet, the intermediary platform including a memory device associated with a processor, each of the vendors providing the intermediary platform with descriptive information relating to each of wares offered by the vendors, the descriptive being information stored in the memory device and comprising a retail sales price and a minimum sales price and a description of the wares offered, for each of the wares, constructing at least one haggle table, the haggle table stored in the memory device associated with the processor located at the intermediary platform, initiating a haggle process by the intermediary platform offering the retail price of each of the wares to the buyers, a buyer responding to the initiating step by communicating to the intermediary platform a first counter offer to the retail price of a first of the wares, and the intermediary platform comparing the counter offer to the minimum sales price of the first of the wares, wherein the haggle table comprises a list of desired discount amounts, used to produce counter offers responsive to a buyer's offer or counter offer for a particular ware offered by at least one of the vendors, the desired discount amount equaling a buyer's offered price deducted from the retail sales price so as to allow a vendor to counteroffer based on a random selection within a pre-defined range. The method further includes continuing the haggle process if the counter offer is not accepted by the intermediary platform, with the intermediary platform determining a second counter offer utilizing the retail sales price, the counter offer, and the minimum sales price, the intermediary platform presenting the second counter offer to the buyer encouraging the buyer to make a third counter offer, further continuing the haggle process for the first of the wares until one of a final offer is accepted, the buyer presents a final counter offer that not accepted by the intermediary platform, and no additional counter offers are made by the buyer or vendor; and the intermediary platform presenting content to the buyer during the haggle process, the content being at least one of textual, visual, verbal, and aural content. In one embodiment, the content is an advertisement. In another embodiment, the content is one of a questionnaire and a survey. Other forms of content include a rebate, a coupon, a search field for accepting buyer input to be searched, a suggested ware for a buyer to purchase directly or to purchase through a haggling process, and a one-time purchase ware, which is ware that a buyer is given the opportunity to buy at a one-time purchase price without the possibility of haggling.

Additional features of the present invention as well as a more detailed description of the invention will be illustrated with respect to the accompanying drawings, which are incorporated in and constitute a part of this specification, which illustrates several embodiments of the invention, and together with the description, serve to explain the principles of the invention.

### BRIEF DESCRIPTION OF THE DRAWINGS

Referring to the drawings:

FIG. 1 illustrates a block diagram of the system of the present invention;

FIG. 2 illustrates a block diagram of a portion of the invention showing the allocation of the inventory;

FIG. 3 is a flow diagram of the present invention;

FIG. 4 is a flow diagram illustrating a haggle method according to the present invention;

FIG. 5 is a flow diagram illustrating a reverse haggle method according to the present invention;

FIG. 6 is a flow diagram illustrating a bulk haggle method according to the present invention;

FIGS. 7 and 8 are flow diagrams illustrating content-triggering methods according to the present invention, which are useful in the haggle methods of FIG. 4, FIG. 5, and FIG. 6; and

FIGS. 9 and 10 are content displays of the content-triggering methods of FIGS. 7 and 8.

### DETAILED DESCRIPTION

As indicated hereinabove, one of the purposes of the system and method of the present invention is reflective of the fact that buyers are endeavoring to reduce the time and effort required in the shopping process in which repeated trips must be made to stores and the mall to competitively purchase various goods and services. While the present invention addresses some deficiencies of the prior art by providing an Internet/telephonic/wireless platform in which a number of vendors can, on a consignment basis or through other type of business relationship, offer their new and used goods or services for sale to a number of buyers, it should be noted that the system and method of the present invention is primarily to be used as a supplement for brick and mortar sales as well as for consummating sales over the wired and wireless mediums. Because the system and method of the present invention would allow many sales of goods and services to be completed largely automatically, the sales force employed by each of the respective vendors would be made more efficient, thereby providing an exceptional opportunity for small and mid-sized businesses to compete for sales on a national level. On a broader basis, distributors, wholesalers, and suppliers of all types may utilize the present invention to manage their supply chain and distribution to retailers on a more individualized manner.

The system 10 of the present invention which would accomplish this end is illustrated in FIG. 1. A plurality of vendors 12, 14 and 16 would use an intermediary 18 as a platform for displaying their goods and services for sale to a plurality of buyers 20, 22 and 24. Intermediary 18 is in communication with vendors 12, 14 and 16, and buyers 20, 22 and 24 over an Internet in a preferred embodiment utilizing computer and/or mobile Internet appliances. Although a large portion of the present invention contemplates the utilization of the Internet/telephonic/wired/wireless services as a sales platform whereby the intermediary develops a website or sales platform, other types of commerce could also employ the present invention. For example, instead of presenting the goods and services over the Internet/telephonic/wired/wireless, the intermediary 18 could be utilized in conjunction with a voice recognition system in which goods or services included in a circular or mail order catalog for sale by the vendors 12, 14 and 16 are sent to various buyers.

FIG. 2 illustrates a more detailed description of the system and method of the present invention than is shown in FIG. 1, in which a vendor 16 and a buyer 24 utilize the intermediary 18 to consummate a sale. Since it is contemplated that many of the vendors would utilize the system and method of the present invention to augment their brick and mortar sales, it is important that inventory be tightly controlled. Therefore, the present invention contemplates a reserve method in which each of the vendors reserve at a minimum, one item/ware in a virtual inventory 26. The vendor's remaining inventory is relegated to an in-store inventory 28. The vendor will then be able to directly manage and regulate inventory using on-line store management functions; and/or the conditional purchase feature. Items need not be taken out of the vendor's general inventory and the vendor would need only to regulate his/her in-store inventory so that sufficient virtual inventory is available for on-line sale through the present invention. Should an item reserved for on-line sale be needed to fill an in-store sale, the vendor must notify the intermediary (such as by phone or by the Internet). When this occurs, that particular item would default to a conditional purchase feature which is designed to salvage what otherwise might be a lost sale. A buyer faced with an “out-of-stock” item is offered the opportunity to order the desired item with delivery made shortly after restocking by that vendor. The vendor would still have the opportunity to sell this item through a straight purchase or haggled method, as described hereinbelow, with an optional discount for the buyer's inconvenience.

As illustrated in FIG. 2, communication is provided between the intermediary 18 and the virtual inventory 26 in a bi-directional manner allowing the intermediary 18 to inform the vendors of the number of items in the virtual inventory 26. Therefore, the vendor would be made aware of the depletion of the virtual inventory 26, allowing the vendor to order or produce more inventory, some of which would be designated as virtual inventory. Likewise, the vendor would inform the intermediary 18 when the vendor is forced to move items from the virtual inventory 26 to the in-store inventory to finalize a sale within the vendor's in-store location. This communication between the vendor 16 and the intermediary 18 could be lessened dramatically if the intermediary is authorized to manage the vendor's entire inventory. For example, if the vendor operates multiple outlets at more than one physical sales location, the inventory control system would track the independent virtual inventory as well as the physical inventory of each of the vendors for each location. Additionally, if the nearest store's inventory is depleted, the inventory control system would direct a purchase order to any other location with sufficient inventory. This would help regulate a chain store's sales through the intermediary and coordinate delivery of the sold item.

The platform of the intermediary 18, namely, the intermediary platform, would be managed by computer systems controlled by a processor 30. The processor 30 would include, among other features, a memory device or simply memory 32 provided with software for operating the system and method according to the present invention as well as a haggle table 34 to control the bargaining process and a voice recognition system 35. The intermediary platform is in communication with vendors 12, 14 and 16, and buyers 20, 22 and 24 over an Internet in a preferred embodiment as set forth above, in which there is a personal computer or other communication device between each of the vendors and the intermediary platform, and there is a personal computer or other communication device between each of the buyers and the intermediary platform. In this example, information from the intermediary platform to the personal computer or other communication device of each buyer is presented to the personal computer or other communication device of each buyer in the form of content, namely, textual, visual, verbal, and/or aural content that is encountered as part of the buyer experience on website of the intermediary platform.

Although it is contemplated that most communication between the buyers and the intermediary would be through the use of the buyer's personal computer over an Internet, wired or wireless device, it is realized that not every buyer has access to a personal computer. Consequently, the voice recognition system 35 would allow each buyer to haggle with the intermediary over the phone. Furthermore, the voice recognition system itself can be eliminated and an electronic exchange could occur between the buyer and the vendor to negotiate a purchase price for a particular item.

The generalized method of the present invention 36 is illustrated in FIG. 3. The intermediary would sign up various vendors at step 38 as participants in the system and method of the present invention or, license its use for proprietary use. This sign-up process could occur in one or more geographic areas. A consignment or other type of sales agreement would be signed between the intermediary 18 and the vendors to give the legal rights to sell or provide a buyer the opportunity to buy a selected number of the vendor's inventory through the various wired or wireless methods. Information such as product images, pricing points and other information pertinent to each of the items for sale would be provided to the intermediary by each of the vendors or incorporated into the vendor's proprietary system if licensed. Alternatively, the intermediary, based upon information provided by the vendors, could provide this information directly to the buyers. The information would then be translated into a presentable form for virtual sales over the Internet and for computerized voice-recognition catalog sales, or through wireless mediums.

The intermediary would also compile a directory including various information provided from each of the vendors. This information could include, but is not limited to, the business name, location information, contact information, a link to the intermediary platform as well as days and hours of operation for the vendor's store locations. The intermediary would operate utilizing a comprehensive search engine and sales assistance known as “Tesa” which would be able to specifically search through the consignment database of goods and services for a buyer's necessities, and present content triggered by during a pending sales transaction or in response to a terminated sales transaction. The consignment database of wares, namely, goods and services, is stored in, or otherwise maintained by, memory 32. The search can be done based upon any combination of listed search criteria such as price ranges, quality of goods and services, physical parameters (if applicable), model number, location, and type of item or natural language search. Tesa would sift through the consignment database for suitable items to display to the buyer for a potential sale. The search can occur in rounds to help narrow down an item, or all at once to allow the buyer an opportunity to “window shop”. Furthermore, a particular function “Tesa” performs is to notify or update a buyer of like, similar, or other items or services from the same or other vendors. Although it has been found that Tesa would operate very efficiently with the system and method of the present invention, other search engines could also be employed.

The vendor provides the intermediary with the product specification at step 40. The virtual inventory is determined at step 42, these items would be then consigned to the intermediary at step 44 for sales to the various potential buyers. Although FIG. 3 illustrates a consignment of goods from the vendor to the intermediary, it is acknowledged that other types of sale arrangements can be used, including licensing the invention for proprietary use.

At this point, the intermediary 18 would give the opportunity to one or more of the buyers to purchase any of the items in the virtual inventory of any of the vendors. This purchase could be consummated in the usual manner in which a retail price associated with each of the items for sale must be met by the buyer. Alternatively, according to the system and method of the present invention, the suggested retail sales price or no price could be used as a starting point for a bargaining or haggling process to be commenced between the vendor and the buyer at step 46. Once this bargaining process has been completed, thereby resulting in the sale of the particular product at a haggled price at step 48, the buyer would pay the intermediary at step 50. At this point, the item would be shipped to the buyer at step 52 and the intermediary would pay the vendor at step 54. Upon any sale, the item is immediately deducted from the vendor's virtual inventory and payment is processed directly to the vendor's demand deposit account or other banking arrangements, as per a service agreement between the vendor and the intermediary. Alternatively, the amount could be credited to the vendor's intermediary account.

Once the buyer has paid the intermediary at step 50, the vendor is notified using various direct links known in the art such as faxes, e-mails, voice mails or the like, of that particular purchase. The vendor may then follow a prescribed procedure to confirm receipt of the order and that processing is underway. The vendor can then confirm the sale to the intermediary and immediately packages the item for delivery by a courier or pick up, in their ordinary course of business.

The present invention in which a consignment sale is effectuated between a vendor and a buyer could utilize three different types of sales techniques. The first technique would be the straight sale in which the vendors would offer their items for sale at a fixed price with possible sales or promotional discounts. The second type would be the auction format adopted by various companies such as Yahoo or E-Bay in which a number of sellers bid among themselves for a particular item offered by a single vendor. The third method of producing a sale, according to the present invention, would be to employ a haggling or bargaining technique in which a single buyer would haggle with a single vendor to determine the sales price of a single item.

This third technique 56 is illustrated in FIG. 4. It is contemplated that this haggling process would automatically be conducted utilizing the intermediary's platform such as its website. Therefore, a haggle table is generated/constructed at step 58. The haggle table is an artificially created reference chart used to calculate the intermediary's counter offers to a buyer's offer or offers. It can be created to suit each of the particular industries utilizing the system and method of the present invention. Therefore, since a plurality of vendors would utilize this system, it is contemplated that several of these haggle tables would be constructed and would be simultaneously maintained by the intermediary. Consequently, although FIG. 4 illustrates the use of a single haggle table, it is noted that a number of these haggle tables would be included in the memory of the intermediary. A standard industry model which the intermediary would construct could be used as a default unless the vendor elects to utilize an alternative for his/her own transactions. Eventually, these haggle tables can be made to reflect different haggling techniques. It is important to note, however, that the haggle tables are flexible to suit any negotiating technique by simply re-setting the benchmark numbers relied upon for the intermediary's counter offers. It is also important to note that the particular haggle table can be created with each particular vendor's input.

Once the haggle table is generated/constructed and included into the memory of the intermediary's platform, and the vendor has applied the retail benchmark price for each of the items offered for sale or the item is “up for bidding” (no suggested retail price provided) at step 60, negotiations between the vendor and the buyer can be commenced to stimulate an exchange and promote sales. At this point, the buyer would make a counter offer to the suggested retail price through the intermediary's platform at step 62 for a particular item. Since it is important that a base benchmark price be established under which that particular item would not be sold, the vendor would also supply to the intermediary a minimum sales price for each of the retail items which would also be included in the intermediary's database and algorithms.

The intermediary notes whether minimum exchanges have occurred at step 64. At this point, the buyer may be given the option to present a final counter offer at step 65 A. The buyer is usually permitted to make a final offer after the first round of haggling has ended. FIG. 4 demonstrates the final offer function at the instance of a transaction, however, this option may be enabled after a designed number of minimum exchanges have occurred between the transacting parties.

Therefore, the buyer and vendor could not present each other a final counter offer until they have attempted to haggle a certain number of times. If the final counter offer function is only engaged after a designated number of minimum exchanges in step 64, the transaction proceeds directly from step 62 to step 68. But, once the final counter offer option is enabled, the transaction proceeds from step 62 to step 64 and so on. This function permits the transacting parties to efficiently determine if a sale can be made. If the buyer elects to present a final counter offer, the intermediary determines whether the buyer's final counter offer is greater than the minimum sale price at step 65 B. If the buyer's final counter offer it is greater, the buyer may consummate the sale at step 65 C. If the buyer's final counter offer is less than the minimum sale price, the intermediary platform ceases/terminates the haggling process without consummating the sale at step 65 D, which locks out the buyer from further haggling for the item.

The present invention would, at step 68, calculate a desired discount amount (DDA) and a most discount offered (MDO) The desired discount amount is determined by subtracting the buyer's offer from the stated retail price. The most discount offered is determined by subtracting the minimum sale price from the stated retail price. The haggle table associated with the particular item for sale would be referenced at each round/exchange of haggling for the desired discount amount to determine a discount haggle (DH) at step 70. The discount haggle is a random number from a determined percent number range that the intermediary determines. In another aspect, the discount haggle is a random number from a predetermined number range that is predefined. This discount haggle is multiplied by the most discount offered to determine an amount which would be subtracted from the stated retail price which would then constitute a counter offer at step 72. At this point, the buyer is presented with the counter offer at step 75 and is then free to purchase the item at that price or continue haggling at step 76 until the intermediary or the buyer make a final offer. If the buyer continues to haggle, the intermediary would replace the stated retail price with a prevailing haggle price for that item and continues the haggling processing as described herein using that prevailing haggle price at each successive exchange.

Additionally, the intermediary will maintain a running count or tally of the successive most discount offered which would involve maintaining a separate and constant record of the most discount offered from the inception of the haggling and subtracting the most discount offered from the product of the most discount offered discount haggle for every round of haggling at step 73. When the most discount offered reaches zero or is within a designated number range, above the minimum sale price as shown by steps 73 A and 73 B, the intermediary can issue a final offer to the buyer. The running count is an internal record of the remaining most discount offered from the start of the haggling and subtracting the product of the discount haggle multiplied by the most discount offered at every exchange between the buyer and the vendor. Please note that the most discount offered represents the highest dollar discount the intermediary is authorized to negotiate with the buyer. When it reaches zero, only the minimum sale price remains to be offered. At that price or within a given range thereto, the intermediary can make a final offer to the buyer for the desired item. At step 75, the buyer is presented with the final offer determined at step 72, and at step 76, the buyer is given the opportunity to consummate the sale or reject the offer and terminate the transaction between the buyer and the vendor for that particular item, which locks the buyer out from continued haggling for the item. Also, if the final offer is made by the buyer and within a designated dollar range of the minimum sale price, the intermediary may forward the offer directly to the vendor for acceptance or rejection. But, if the vendor does not respond within a certain time period, such as 30 seconds, 45 seconds, 60 seconds, etc., the final offer is deemed rejected.

Because of the possibility of unfairness to the vendor or the buyer, the intermediary may impose artificial restrictions on the successive haggling process so that the counter offers remain orderly. For example, a successive haggle price by the buyer made at or below the first haggle price or any subsequent haggle price, may trigger a modified counter offer from the intermediary. If this occurs, the intermediary can respond by reiterating the last haggle price and/or noting the unfairness, or by initiating a lockout locking the buyer out from further bidding. Alternatively, the present invention could continue haggling based on buyer's last counter offer and irrespective of the unfairness, but so long as the final sale price is above the minimum sale price. Finally, a search engine, such as Tesa, could be employed to search for an item of comparable value to the unfair counter offer or present available rebates or discounts to the buyer. Furthermore, since the buyer might be aware of the existence of the minimum sale price and therefore would continue to haggle to endeavor to obtain this lowest possible price, a final offer could be triggered after a specified or predetermined number of exchanges have been made between the buyer and the intermediary for a particular item.

Although it is contemplated that the haggle system of bargaining be conducted strictly between the buyer and the intermediary, based upon various restrictions which might be imposed by the vendor, it is possible to permit a direct exchange with the vendor. Although it might not be advisable for the vendor to personally respond to every round of haggling because of the difficulty in managing such an operation, certain vendors may find a direct exchange with the vendor helpful for their industry.

An example illustrating the haggling process shown in FIG. 4 will now be given. If the buyer counters with a $75 offer for an item listed at a retail price of $110 and a minimum sales price designated at $90, the intermediary would initially determine the desired discount amount which would be ($110-$75) which would equal $35. The intermediary has already determined that the most desired (MDO) would be $25 ($110-$90). Checking the haggle table for the desired discount amount of $35 for that item or service, the intermediary may therefore only negotiate the determined amount of the most discount offered in accordance with the haggle table criteria. A random number corresponding to the desired discount amount is determined (the discount haggle) from the haggle table and is multiplied by the most discount offered. Assuming that the random number chosen is 23.5% and that the most discount offered of $25 is utilized, then the counter offer would be $25 multiplied by 23.5% or $5.87, minus the stated retail price of $110, resulting in a counter offer of $104.13. The intermediary would then confirm that the intermediary's offering price is above the minimum sale price and whether a final offer is appropriate. If this is the case, the intermediary would present the counter offer to the buyer an amount of $104.13. At this point, the buyer is free to purchase the item at that price or continue haggling until the intermediary makes an acceptable a final offer or haggling ceases. The haggling can cease due to a loss of interest. And so in response to no presenting of additional counter offers by the buyer and the intermediary platform, which constitutes no action or a loss of interest, the intermediary platform ceases/terminates the haggling process at step 65 D, which locks the buyer out from haggling further for the item. If the buyer continues to haggle, the intermediary replaces the stated retail price with the prevailing haggle price for that item and the minimum sale price is then subtracted from the prevailing price to determine the current most discount offered, and the running count for the most discount offered is updated.

Both the buyer and the intermediary are able to make a final offer to each other using this process. The buyer may do so at any time during the haggling process with some systemic limitations. This would simply require inputting the desired price and clicking on a final offer icon if the Internet is utilized. The intermediary would determine whether this amount is above the minimum sale price and would respond accordingly.

The intermediary could issue a final offer upon depletion of the most discount offered or at a point which the prevailing price of an item is within a desired range to the minimum sale price. This would be achieved after successive haggling and vendors or the intermediary may also designate a period when a final offer must be made in order to move the process along. It is important to note that the final offer does not necessarily have to be the minimum sale price. The intermediary may present a final offer within a given percentage or dollar amount above or, if authorized, below the minimum sale price.

FIG. 5 illustrates an alternative 78 to the haggling process described in relation to FIG. 4. This alternative is characterized as a reverse haggling process. This process permits a vendor to allow a buyer to start the haggling process with their own offer for a good or service. In this process, the vendor would display an item or service for sale without a price and the buyer would then offer a price for that item. To assist the buyer in determining at least an initial offer price, the intermediary may display the average selling price of that particular item which was reached based upon previous haggling of that item with other buyers. As shown at step 80, a reverse haggle table would be constructed. At this point, the buyer would make an offer to the intermediary at step 82. The intermediary would determine and verify if minimum exchanges occurred at step 84. The intermediary would then determine if the buyer made a final offer at step 85 A. If so, the intermediary confirms whether the final offer is above the minimum sale price at step 85 B.

The sale is consummated with the buyer, at step 85 C, if the buyer's final offer is above the minimum sale price. However, if the buyer's final offer is below the minimum sales price, the intermediary rejects the final offer and terminates the sale and ceases/terminates the haggling process in a prescribed manner at step 85 D, which locks the buyer out from haggling further for the item. The desired discount amount is referenced to the reverse haggle table to determine the discount haggle at step 90. The intermediary would then multiply the discount haggle with the most discount offered and then subtract that result from the suggested retail price to determine the intermediary's counter offer at step 92.

At step 93 A, the intermediary determines whether the most discount offered is zero or within the intermediary's final offer range. If so, the intermediary confirms that the final offer is above the minimum sale price at step 93 B. If the intermediary's final offer is above the minimum sale price, the intermediary presents the final offer to the buyer and waits a designated time period, such as 30 seconds, 45 seconds, 60 seconds, etc. for the buyer's response at step 96. The buyer may consummate the sale at step 85 C. In response to the buyer rejecting a final offer presented by the intermediary platform, the intermediary platform cease/terminate the haggling process/transaction at step 85 D, which locks the buyer out from haggling further for the item. The intermediary platform also ceases/terminates the haggling process/transaction at step 85 D if the buyer fails to respond to a counter offer presented by the intermediary platform within the designated time period or otherwise before the designated time period expires, which locks the buyer out from haggling further for the item. In a particular embodiment, the intermediary platform also ceases/terminates the haggling process/transaction at step 85 D if the intermediary platform fails to respond to a counter offer presented by the buyer within the designated time period or otherwise before the designated time period expires.

During this process, the desired discount amount and the most discount offered are determined at step 88. If the intermediary's final offer is not above the minimum sale price at step 93 B, the intermediary presents the buyer with the intermediary's offer, derived at step 92, as the intermediary's final offer. The buyer may then accept/agree to the final offer or reject it at step 96. If accepted, the buyer consummates the transaction at step 85 C; or if rejected, the sale is terminated at step 85 D. If the most discount offered is not zero or within the final offer range, this counter offer would be presented to the buyer at step 95 and the buyer may accept/agree to the counter offer; reject and terminate; or reject and counter offer at step 96. If the buyer accepts/agrees, the transaction is consummated at step 85 C.

If the buyer rejects the offer and terminates, the transaction is terminated at step 85 D. Or, if the buyer rejects the offer and makes a subsequent offer, the haggling process returns to step 82, until the transaction is consummated or terminated. The vendor may require a minimum number of with the buyer to permit the haggling process to continue.

FIG. 6 illustrates another embodiment to the haggle process shown in FIG. 4. Consequently, we have included similar reference numerals. This alternative 98 creates a bulk haggling scenario which would enable buyers of multiple items associated with one or more of the vendors to counter offer a total price off the calculated stated retail price of all of the items. As was true with respect to FIG. 4, a haggle table is constructed at step 58. This haggle table consists of the exact table or tables created with respect to the algorithm of FIG. 4. If a buyer selects multiple goods to be purchased, the intermediary would provide the buyer with a total retail price for all the goods, as well as internally calculates the total minimum sale prices at step 102 to form the required pricing points to haggle. The buyer would then make an offer to the intermediary for all of the goods at step 104. At this time, the intermediary would determine whether the offer is greater than the total minimum sale price and would determine whether minimal exchange has occurred at step 64. If this is not the case, the desired discount amount as well as the most discount offered or most percentage discount offered for each of the items would be determined at step 68 and the comparison similar to what is described with respect to FIG. 4 is made at step 70. The discount haggle is multiplied by the most discount offered and subtracted from the total retail price to determine the counter offer at step 72. A counter offer is then made and haggling is either discontinued and a sale consummated or the haggling would continue in a similar manner. If the buyer's offer to the intermediary at step 104 is greater than the total minimum sale price, the sale of all of the items could be consummated at that point or, similar to the scenario described with respect to FIG. 4, if the vendor or vendors would insist upon a predetermined number of exchanges between the buyer and seller, the haggling process would continue. It is noted that each of the vendors would have an option as to whether they wish to engage in this bulk haggling feature. By aggregating potential discounts, vendors will have the opportunity to institute a cooperative selling method and provide larger total discounts to the buyers, thereby benefitting both buyers and vendors by creating incentives to buy and sell more items.

Particularly if more than one vendor is involved in the bulk haggling process, it is important to partition the discount haggle for each of the purchase items which is shown at step 120. This is necessary since there is a potential for the buyer to return one or more items of the total number of items purchased utilizing this method. Should a buyer desire to return one or more of the bulk haggled items, a definitive price must be stated to permit credit or exchange.

This cooperative selling method aggregates the total most discount offered to potentially award a larger overall discount on the total purchase. The buyer can take advantage of the aggregate most discount offered and maximize the buyer's discount haggle to thereby help consummate sales at a maximum value. The intermediary would maintain a running count of the total discount haggle and calculate at what price each item is finally sold by determining the individual discount haggle. The intermediary is also able to provide a final sale price for each item by first apportioning from the total sale price the minimum sale price for each purchased item and then calculating and apportioning the dollar value of the remaining individual discount haggle on top of the minimum sale price. The individual dollar value of the discount haggle is derived by calculating the individual most discount offered for that item and dividing it by the aggregate most discount offered giving the portion of the discount that item offers to the bulk haggle and multiplying that amount by the amount above the aggregate minimum sale price. This amount of the aggregate minimum sale price equals the total final sale price minus the aggregate minimum sale price of the desired items to be purchased. Note that the final sale price must always be above the aggregate minimum sale price since no individual item may be sold below its minimum sale price.

In all of the embodiments discussed, the most discount offered is constantly updated after each round of haggling to reflect the amount of discount haggled (discount already negotiated) by the buyer in the preceding rounds of haggling. Additionally, the running count of each and every negotiation is valuable for business and marketing analysis and study, as well as a means to trigger a final offer from the intermediary.

As explained above, at steps 65 D and 85 D of the haggling methods described above, the intermediary platform ceases/terminates the haggling process, and these steps 65 D and 85 D are represented in FIG. 7. According to the principle of the invention, in response to the intermediary platform ceasing/terminating the haggle process at step 65 D and also at step 85 D, the method further includes the intermediary platform presenting content to the buyer at step 100. The content, which is both reinitiating content and non-reinitiating content as will be described below, is presented on the personal computer or other communication device between the buyer and the intermediary platform. In this example, the intermediary platform is in communication with the personal computer or other communication device of each of the vendors via the Internet, and the intermediary platform is in communication with the personal computer or other communication device of each of the buyers via the Internet.

The content is at least one of textual, visual, verbal, and aural content consistent with the normal and customary definition of the term “content.” A combination of two or more of the named content forms can also be used as the content, such as audio/visual/video content. The content can be reinitiating content 100A including at least one advertisement, such as advertisement 110, at least one questionnaire, such as questionnaire 111, at least one survey, such as a survey 112, or other selected reinitiating content. This reinitiating content 100A can be third-party content presented by the intermediary platform via website plugins or other conventional format. The advertisement can be an advertisement for a ware or wares offered by a vendor through the intermediary platform. According to the principle of the invention, the buyer is free to transact or conventionally interact with the reinitiating content 100A, such as with a mobile device, or with a pointing device, keyboard and/or other input device associated with the personal computer of the buyer, for transacting/interacting with the reinitiating content, namely, accessing/viewing the reinitiating content 100A for the purpose of viewing advertisement 110, filling out questionnaire 111, or filling out survey 112.

At step 121, the intermediary determines whether the buyer interacts with the reinstating content 100A, including at least one of advertisement 110, questionnaire 111, and survey 112 in the present embodiment. If so, the intermediary platform is responsive by reinitiating the haggle process at step 122 between the intermediary platform and the buyer for the item/ware for which a bargain was not reached in the original haggling process. Reinitiating the haggle process at step 122 includes reinitiating step 60 in the haggle method of FIG. 4, reinitiating step 82 in the haggle method of FIG. 5, or reinitiating step 102 in the haggle method of FIG. 6. This reinitiating of the haggle process allows the haggle process to continue for the item/ware for which a bargain was not reached in the first or initial haggle process terminated at step 65 D or 85 D. And so if a buyer is dissatisfied with a terminated haggle process and wishes to continue to try and haggle for the item/ware in the haggle methods of FIGS. 4-6, the buyer need only transact/interact with the reinstating content 100A, such as by viewing advertisement 110, filling out questionnaire 111, or filling out survey 112. This forces a user to interact with reinstating content 100A in order to allow the buyer to have another opportunity to haggle for the item/ware according to the principle of the invention. This forced content interaction forces/requires a buyer to interact with the reinstating content 100A in order to gain access to another chance to haggle for the item/ware. In other words, presentation of the reinstating content 100A to the buyer allows the buyer another chance at the same ware if the buyer views an advertisement, answers a questionnaire, answers a survey, or otherwise transacts/interacts with the particular reinstating content provided by the intermediary platform. This creates the opportunity to salvage the sale between the buyer and the vendor.

At step 121, the intermediary determines whether the buyer transacts/interacts with the reinstating content 100A, including at least one of advertisement 110, questionnaire 111, and survey 112 in the present embodiment, as explained above. If not, whether by deleting/closing the reinstating content 100A or by failing to interact with the reinstating content 100A within a designated period of time from when the reinstating content 100A was presented to the buyer, such as a period of time of 30 seconds, 45 seconds, 60 seconds, or other designated time period, the intermediary platform is responsive by permanently rejecting/terminating the transaction at step 130, which prevents the buyer from haggling for the item/ware for which a bargain was not reached in the first or initial haggle process terminated at step 65 D or 85 D.

The buyer transacting/interacting with at least one of the reinitiating content 100A, which in this case includes advertisement 110, questionnaire 111, and survey 112, triggers a reinitiating of the haggle process. In an alternate embodiment, other forms of content, defined as non-reinitiating content 100B, that do not trigger a reinitiating of the haggle process may be presented as part of the content presented at step 100 and may include such non-reinitiating content 100B as a search box/field 113 for accepting buyer input to be searched, a rebate 114, a coupon 115, a suggested ware 116 for a buyer to purchase directly or to purchase through a haggling process, and a one-time purchase ware 117, which is ware that a buyer is given the opportunity to buy at a one-time purchase price without the possibility of haggling, which will now be discussed.

And so at step 121, the intermediary determines whether the buyer transacts/interacts with the reinstating content 100A, including at least one of advertisement 110, questionnaire 111, and survey 112 in the present embodiment, as explained above. If not, in the case where the content includes non-reinitiating content 100B, at step 123 the intermediary platform determines whether the buyer transacts/interacts with the non-reinstating content 100B, including at least one of search box/field 113, rebate 114, coupon 115, suggested ware 116, and one-time purchase ware 117. If so, intermediary platform is responsive by permanently rejecting/terminating the transaction at step 130, and at step 125 the buyer transacts the selected non-reinitiating content. If not, whether by deleting/closing the non-reinstating content 100B or by failing to transact/interact with the non-reinstating content 100B within a designated period of time from when the non-reinstating content 100B was presented to the buyer, such as a period of time of 30 seconds, 45 seconds, 60 seconds, or other designated time period, the intermediary platform is responsive by permanently rejecting/terminating the transaction at step 130, which prevents the buyer from haggling for the item/ware for which a bargain was not reached in the first or initial haggle process terminated at step 65 D or 85 D.

Search box/field 113 is for accepting buyer input to be searched for in memory 32 of the intermediary platform, and for accepting buyer input to be searched for externally, such as externally, in the consignment database of wares of memory 32 of the intermediary platform, or both. This feature allows a buyer to search for similar or other wares both in memory 322 to haggle for in the haggle methods set forth throughout this specification, and externally.

Rebate 114 is a ticket or document that can be exchanged for a financial discount when purchasing a ware. Rebate 114 is, moreover, an allowance of a return of a part of the purchase price for the ware. The ware can be any ware. Rebate 114 can relate to the purchase of any ware, including a third party ware, without the use of a haggle process, or with the use of a haggle process via the consummation of a sale in the haggle methods set forth throughout this specification, such as at step 65 C and at step 85 C. And so rebate 114 can be for a third party ware unrelated to the consignment database, or, in a preferred embodiment, for a ware from the consignment database of wares of memory of the intermediary platform, and preferably any like or similar ware to the one for which a bargain was not reached in the first or initial haggle process terminated at step 65 D or 85 D. Rebate 114 can be exchanged for financial discount when purchasing a ware, including purchasing a third party ware or purchasing a ware via the consummation of a sale in the haggle methods set forth throughout this specification, such as at step 65 C and at step 85 C. Rebate 114 is preferably an instant rebate, which is available immediately at the time the sale is consummated. In an alternate embodiment, the rebate is a mail-in-rebate.

Coupon 115 is a ticket or document that can be exchanged for a financial discount when purchasing a ware. The ware can be any ware. Coupon 115 can relate to the purchase of any ware, including a third party ware, without the use of a haggle process, or with the use of a haggle process via the consummation of a sale in the haggle methods set forth throughout this specification, such as at step 65 C and at step 85 C. And so coupon 115 can be for a third party ware unrelated to the consignment database, or, in a preferred embodiment, for a ware from the consignment database of wares of memory of the intermediary platform, and preferably any like or similar ware to the one for which a bargain was not reached in the first or initial haggle process terminated at step 65 D or 85 D. Coupon 115 can be exchanged for financial discount when purchasing a ware, including purchasing a third party ware or purchasing a ware via the consummation of a sale in the haggle methods set forth throughout this specification, such as at step 65 C and at step 85 C.

Coupon 115 is preferably an electronic coupon, such as an Internet coupon or a mobile coupon. As is well-known, an Internet coupon often refers to coupons as “coupon codes”, “promotional codes”, “promotion codes”, “discount codes”, “key codes”, “promo codes”, “surplus codes”, “portable codes”, “shopping codes”, “voucher codes”, “reward codes”, “discount vouchers” or “source codes”. Internet coupons typically provide for reduced cost or free shipping, a specific dollar or percentage discount, or some other offer to encourage consumers to purchase specific items. Because paper coupons are more difficult to redeem, typically secret words or codes are distributed for consumers to type in at checkout, such as at the consummation of a sale. As is well-known, a mobile coupon is an electronic ticket solicited and or delivered to a mobile phone that can be exchanged for financial discount when purchasing a ware, such as a third party ware or via the consummation of a sale in the haggle methods set forth throughout this specification, such as at step 65 C and at step 85 C. Mobile coupons are often distributed through WAP Push, over SMS or MMS, or other mobile means to a buyer's mobile device, which is redeemed at the consummation of a sale.

Suggested ware 116 is a post of a ware that may be of interest to the buyer, such as a third part ware unrelated to the consignment database of the intermediary platform, or a ware from the consignment database of wares of memory of the intermediary platform that a buyer may select for initiating a haggle process according to the invention. Preferably, the suggested ware is any like or similar ware to the one for which a bargain was not reached in the first or initial haggle process terminated at step 65 D or 85D. In response to the buyer transacting/interacting with this content by selecting suggested ware 116, such as with a mobile device, or such as with a pointing device, keyboard and/or other input device associated with the personal computer of the buyer, the intermediary platform is responsive by initiating the haggle process between the intermediary platform and the buyer for suggested ware 116 if the suggested ware is from the consignment database. If the suggested ware is not from the consignment database, the buyer may be taken to a third party website to purchase the suggested ware. Initiating the haggle process for suggested ware 116 includes, for instance, step 60 in the haggle method of FIG. 4, step 82 in the haggle method of FIG. 5, or step 102 in the haggle method of FIG. 6. If the suggested ware is from the consignment database, the buyer may be given an option to bypass the haggle process and proceed directly to consummate the sale of the suggested ware. Furthermore, the content can include a plurality of suggested wares from which to choose from.

One-time purchase ware 117 is a post of a ware that a buyer is given the opportunity to buy at a one-time purchase price without the possibility of haggling, and this type of ware is, for instance, a ware that may be of interest to the buyer, such as a third part ware unrelated to the consignment database of the intermediary platform, or a ware from the consignment database of wares of memory of the intermediary platform. Preferably, the one-time purchase ware 117 is any like or similar ware to the one for which a bargain was not reached in the first or initial haggle process terminated at step 65 D or 85 D. In response to the buyer transacting/interacting with this content by selecting one-time purchase ware 117, such as with a mobile device, or such as with a pointing device, keyboard and/or other input device associated with the personal computer of the buyer, the intermediary platform is responsive by consummating the sale of that one-time purchase ware 117 if the one-time purchase ware 117 is from the consignment database. If the one-time purchase ware 117 is not from the consignment database, the buyer may be taken to a third party website to purchase the one-time purchase ware 117. Furthermore, the content can include a plurality of one-time purchase wares from which to choose from.

As explained above, the intermediary platform presents content at step 100 in response to the intermediary platform ceasing/terminating the haggle process at step 65 D and also at step 85 D. In an alternate embodiment, step 100 of intermediary platform presenting content is carried out at any time during a pending haggle process according to the principle of the invention, including at any time from the initiation of a haggle process to a ceasing/terminating of a haggle process, and this will now be discussed briefly in connection with FIG. 9.

At step 100 in FIG. 8 during a pending haggle process or transaction, intermediary platform presents content to the buyer during the haggle process, namely, during a pending or ongoing haggling process or transaction from the beginning of the haggling process or transaction to before the consummation of a sale or the termination of a haggling process or transaction. The content is both the reinitiating content and non-reinitiating content discussed above. The intermediary platform presenting the content during a haggling process or transaction is random according to the programming of processor 30 of intermediary platform. In the alternative, processor 30 may be programmed to present content to the buyer at one or more predetermined intervals during a haggling process or transaction. At step 135, the intermediary determines whether the buyer transacts/interacts with the content. If not, whether by deleting/closing the content, clicking on a continue haggle button as is described below, or by failing to transact/interact with the content within a designated period of time from when the content was presented to the buyer, such as a period of time of 30 seconds, 45 seconds, 60 seconds, or other designated time period, the intermediary platform is responsive by resuming the transaction at step 137. If so, at step 136 the buyer transacts the selected content, after which at step 137 the intermediary platform resumes the transaction. This process can be repeated any desired number of times during a haggle process or transaction. To forestall nuisance, it is preferred that this process take place no more than perhaps two or three times during a pending haggle process or transaction.

The presentation of the content can take be displayed in many ways, and in many forms and designs without departing from the invention, and each content type can be presented individually, or in a group or composite. Examples of the display presentation of content by intermediary platform are shown in FIG. 9 and FIG. 10. FIG. 9 is an example of a presentation of content after a transaction is ceased or terminated, and an example of the presentation of content by the intermediary platform during a transaction is shown in FIG. 10. The examples of the displays of content in FIGS. 9 and 10 is shown merely as a matter of example of how the display of the content may be presented.

In FIGS. 9 and 10, the content is presented in fields in a window or web page, denoted at 140. In FIG. 9, field 141 identifies the ware for which a bargain was not reached in the first or initial haggle process terminated at step 65 D or 85 D, field 142 includes the advertisement 110, questionnaire 111, survey 112, and search box/field 113, including a search input for accepting buyer input to be searched for in memory 32 of the intermediary platform, and a second search input for accepting buyer input to be searched for externally, and field 143 includes posts suggested wares 116, rebate 114, coupon 115, and a one-time purchase ware 117. Advertisement 110, questionnaire 111, and survey 112 in field 142 are conventional buttons, e.g., hyperlink buttons, that may be clicked for accessing and transacting/interacting with the content, such as for viewing advertisement 110, filling out questionnaire 111, and taking survey 112. Search box/field 113 is entirely conventional and is used to input search terms for searching in memory 32 and for searching external content. Suggested wares 116, rebate 114, coupon 115, and one-time purchase ware 117 are also conventional buttons, e.g., hyperlink buttons, that may be clicked for transacting/processing/interacting with those respective contents.

In FIG. 10, field 141 identifies the ware for which a transaction is pending, field 142 includes advertisement 110, questionnaire 111, survey 112, and search box/field 113, including a search input for accepting buyer input to be searched for in memory 32 of the intermediary platform, and a second search input for accepting buyer input to be searched for externally, and field 143 includes posts suggested wares 116, rebate 114, coupon 115, and one-time purchase ware 117. As in FIG. 9, in FIG. 10 advertisement 110, questionnaire 111, and survey 112 in field 142 are conventional buttons, e.g., hyperlink buttons, that may be clicked for accessing and transacting/interacting with the content, such as for viewing advertisement 110, filling out questionnaire 111, and taking survey 112. Search box/field 113 is entirely conventional and is used to input search terms for searching in memory 32 and for searching external content. Suggested wares 116, rebate 114, coupon 115, and one-time suggested ware 117 are also conventional buttons, e.g., hyperlink buttons, that may be clicked for processing/interacting with those respective contents. Because the content presented in FIG. 10 is during a pending transaction, a continue haggle button, denoted at 138, is also presented. Button 138, which is a hypertext button in this embodiment, is in field 141 in the present embodiment, but may be located elsewhere. When the content as in FIG. 10 appears during a pending transaction, a buyer may transact/interact with the content as described above, or bypass the content and continue the haggling process transaction for the ware for which the transaction is pending simply by selecting via clicking the continue haggle button 138.

The invention has been described above with reference to preferred embodiments. However, those skilled in the art will recognize that changes and modifications may be made to the embodiments without departing from the nature and scope of the invention. Various changes and modifications to the embodiments herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. A method of facilitating the sale of wares offered from vendors to buyers and for triggering content to the buyers, the method comprising the steps of:
providing an intermediary platform in communication with vendors and buyers over an Internet, the intermediary platform comprising a memory device associated with a processor;
each of the vendors providing the intermediary platform with descriptive information relating to each of wares offered by the vendors, the descriptive information stored in the memory device and comprising a retail sales price and a minimum sales price and a description of the wares offered, for each of the wares;
constructing at least one haggle table, the haggle table stored in the memory device associated with the processor located at the intermediary platform;
initiating a haggle process by the intermediary platform offering the retail price of each of the wares to the buyers;
a buyer responding to the initiating step by communicating to the intermediary platform a first counter offer to the retail price of a first of the wares;
the intermediary platform comparing the counter offer to the minimum sales price of the first of the wares;
wherein the haggle table comprises a list of desired discount amounts, used to produce counter offers responsive to a buyer's offer or counter offer for a particular ware offered by at least one of the vendors, the desired discount amount equaling a buyer's offered price deducted from the retail sales price so as to allow a vendor to counteroffer based on a random selection within a pre-defined range;
continuing the haggle process if the counter offer is not accepted by the intermediary platform, with the intermediary platform determining a second counter offer utilizing the retail sales price, the counter offer, and the minimum sales price;
the intermediary platform presenting the second counter offer to the buyer encouraging the buyer to make a third counter offer;
further continuing the haggle process for the first of the wares until one of a final offer is accepted, the buyer presents a final counter offer that not accepted by the intermediary platform, and no additional counter offers are made by the buyer or vendor;
the intermediary platform terminating the haggle process for the first of the wares in response to no accepting of a final offer, the buyer presenting a final counter offer that is less than the minimum sales price, and no presenting of additional counter offers by the buyer and the intermediary platform; and
in response to the intermediary platform terminating the haggle process for the first of the wares, the intermediary platform presenting content to the buyer, the content being at least one of textual, visual, verbal, and aural content.

2. The method according to claim 1, further comprising:
the buyer interacting with the content; and
the intermediary platform reinitiating the haggle process between the intermediary platform and the buyer for the first of the wares in response to the buyer interacting with the content.

3. The method according to claim 2, wherein the content further comprises an advertisement.

4. The method according to claim 2, wherein the content further comprises one of a questionnaire and a survey.

5. The method according to claim 1, wherein the content further comprises one of a rebate and a coupon.

6. The method according to claim 1, wherein the content further comprises a search field for accepting buyer input to be searched.

7. The method according to claim 1, wherein the content further comprises one of at least one suggested ware for the buyer to purchase or haggle for in the haggle process, and at least one one-time purchase ware that the buyer is given the opportunity to buy at a one-time purchase price without the possibility of haggling.

8. A method of facilitating the sale of wares offered from vendors to buyers and for triggering content to the buyers, the method comprising the steps of:
providing an intermediary platform in communication with vendors and buyers over an Internet, the intermediary platform comprising a memory device associated with a processor;
each of the vendors providing the intermediary platform with descriptive information relating to each of wares offered by the vendors, the descriptive information stored in the memory device and comprising a retail sales price and a minimum sales price and a description of the wares offered, for each of the wares;
constructing at least one haggle table, the haggle table stored in the memory device associated with the processor located at the intermediary platform;
initiating a haggle process by the intermediary platform offering the retail price of each of the wares to the buyers;
a buyer responding to the initiating step by communicating to the intermediary platform a first counter offer to the retail price of a first of the wares;
the intermediary platform comparing the counter offer to the minimum sales price of the first of the wares;
wherein the haggle table comprises a list of desired discount amounts, used to produce counter offers responsive to a buyer's offer or counter offer for a particular ware offered by at least one of the vendors, the desired discount amount equaling a buyer's offered price deducted from the retail sales price so as to allow a vendor to counteroffer based on a random selection within a pre-defined range;
continuing the haggle process if the counter offer is not accepted by the intermediary platform, with the intermediary platform determining a second counter offer utilizing the retail sales price, the counter offer, and the minimum sales price;
the intermediary platform presenting the second counter offer to the buyer encouraging the buyer to make a third counter offer;
further continuing the haggle process for the first of the wares until one of a final offer is accepted, and one of the buyer and the intermediary platform fails to respond to a counter offer within a designated time period;
the intermediary platform terminating the haggle process for the first of the wares in response to one of the buyer and the intermediary platform failing to respond to a counter offer within the designated time period; and
in response to the intermediary platform terminating the haggle process for the first of the wares, the intermediary platform presenting content to the buyer, the content being at least one of textual, visual, verbal, and aural content.

9. The method according to claim 7, further comprising:
the buyer interacting with the content; and
the intermediary platform reinitiating the haggle process between the intermediary platform and the buyer for the first of the wares in response to the buyer interacting with the content.

10. The method according to claim 9, wherein the content further comprises an advertisement.

11. The method according to claim 9, wherein the content further comprises one of a questionnaire and a survey.

12. The method according to claim 8, wherein the content further comprises one of a rebate and a coupon.

13. The method according to claim 8, wherein the content further comprises a search field for accepting buyer input to be searched.

14. The method according to claim 8, wherein the content further comprises one of at least one suggested ware for the buyer to purchase or haggle for in the haggle process, and at least one one-time purchase ware that the buyer is given the opportunity to buy at a one-time purchase price without the possibility of haggling.

15. A method of facilitating the sale of wares offered from vendors to buyers and for triggering content to the buyers, the method comprising the steps of:
providing an intermediary platform in communication with vendors and buyers over an Internet, the intermediary platform comprising a memory device associated with a processor;
each of the vendors providing the intermediary platform with descriptive information relating to each of wares offered by the vendors, the descriptive information stored in the memory device and comprising a retail sales price and a minimum sales price and a description of the wares offered, for each of the wares;
constructing at least one haggle table, the haggle table stored in the memory device associated with the processor located at the intermediary platform;
initiating a haggle process by the intermediary platform offering the retail price of each of the wares to the buyers;
a buyer responding to the initiating step by communicating to the intermediary platform a first counter offer to the retail price of a first of the wares;
the intermediary platform comparing the counter offer to the minimum sales price of the first of the wares;
wherein the haggle table comprises a list of desired discount amounts, used to produce counter offers responsive to a buyer's offer or counter offer for a particular ware offered by at least one of the vendors, the desired discount amount equaling a buyer's offered price deducted from the retail sales price so as to allow a vendor to counteroffer based on a random selection within a pre-defined range;
continuing the haggle process if the counter offer is not accepted by the intermediary platform, with the intermediary platform determining a second counter offer utilizing the retail sales price, the counter offer, and the minimum sales price;
the intermediary platform presenting the second counter offer to the buyer encouraging the buyer to make a third counter offer;
further continuing the haggle process for the first of the wares until one of a final offer is accepted, the buyer presents a final counter offer that not accepted by the intermediary platform, and no additional counter offers are made by the buyer or vendor;
the intermediary platform presenting content to the buyer during the haggle process, the content being at least one of textual, visual, verbal, and aural content.

16. The method according to claim 15, wherein the content further comprises an advertisement.

17. The method according to claim 15, wherein the content further comprises one of a questionnaire and a survey.

18. The method according to claim 15, wherein the content further comprises one of a rebate and a coupon.

19. The method according to claim 15, wherein the content further comprises a search field for accepting buyer input to be searched.

20. The method according to claim 15, wherein the content further comprises one of at least one suggested ware for the buyer to purchase or haggle for in the haggle process, and at least one one-time purchase ware that the buyer is given the opportunity to buy at a one-time purchase price without the possibility of haggling.
